(19) United States
(12) Patent Application Publication
(10) Pub. No.: US 2024/0127313 A1
(43) Pub. Date: Apr. 18, 2024

(54) A SHOPPING CART AND CHECKOUT CONTROLLER SUBSYSTEM FOR AN E-COMMERCE PLATFORM

(71) Applicant: Christopher MOONEY, Melbourne (AU)

(72) Inventor: Christopher MOONEY, Melbourne (AU)

(21) Appl. No.: 18/547,816

(22) PCT Filed: Feb. 24, 2022
(86) PCT No.: PCT/AU2022/050148

§ 371 Date: Aug. 24, 2023

(30) Foreign Application Priority Data
Feb. 25, 2021 (AU) 2021900512

(51) Int. Cl. G06Q 30/0601; G06F 21/60

(52) U.S. Cl. CPC G06Q 30/0633; G06F 21/602

(57) ABSTRACT

A shopping cart and checkout controller subsystem for an e-commerce platform serving webpages for a plurality of retail items has a shopping cart controller configured to receive a selected retail item from a respective web page and add the selected retail items to a respective shopping cart by associating the selected retail item with at least one of a respective browser session and a user profile. The subsystem also has a checkout controller processing the purchase of the selected retail item for a retail price including with input payment details. The subsystem is configured to detect when a number of retail items of the same type is added to a plurality of shopping carts and to control the checkout controller to adjust the retail price of the retail item.

### FIELD OF THE INVENTION

This invention relates generally to a shopping cart and checkout controller subsystem for an e-commerce platform.

### BACKGROUND OF THE INVENTION

E-commerce retail platforms typically comprise a server in operable communication with a plurality of client devices across a wide area network.

The retail platform comprises a database of retail items and a web server which serves a plurality of respective webpages in relation to the retail items. Each web page displays information in relation to each retail item, including the retail price.

A user browsing these retail item webpages may select retail items for adding to a shopping cart for subsequent checkout.

Adding a retail item to a shopping cart involves associating a selected retail item either with browser session data (if a user is not logged in) or against a user profile (if the user is logged in). Terminating the browser session will lose data from the browser session data whereas shopping cart data stored against the user profile persists across browser sessions.

The present invention seeks to provide a system which will modify the conventional behaviour of shopping cart and checkout functionality of e-commerce platforms, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a shopping cart and checkout controller subsystem for an e-commerce platform. The e-commerce platform serves webpages for a plurality of retail items and the subsystem has a shopping cart controller which is configured to receive selected retail items from respective webpages and add the selected retail items to a respective shopping cart, either by associating the selected retail item with user rather session data or storing the selected retail item against a user profile.

The subsystem further comprises a checkout controller which processes the purchase of selected retail items including processing payment therefor using provided payment details.

The present subsystem may complement or replace shopping cart and checkout functionality of an e-commerce retail platform. For example, the shopping cart controller of the subsystem may interface with an existing shopping cart module of the retail platform to receive checkout event notifications therefrom and wherein the present shopping cart controller of the subsystem modifies the retail item webpages and controls the functionality of the checkout controller.

Similarly, the present checkout controller of the subsystem may replace or alternatively complement an existing checkout controller of an existing e-commerce retail platform. For example, the checkout controller of the present subsystem may adjust retail item pricing at the time of checkout of an existing e-commerce retail platform checkout module.

The present subsystem may be added to an existing e-commerce retail platform by way of server-side plug-in or implemented by way of client-side code, such as JavaScript or browser plug-in.

The present subsystem is configured to detect when a number of retail items of the same type are added to a plurality of shopping carts of various users and to control the checkout controller to adjust the retail price of the retail item accordingly.

In this way, for example, a plurality of users may add the same retail item to their shopping cart and/or wish list with a view to potentially obtaining the item at a lower price at a later stage.

In embodiments, the present shopping cart controller may modify the retail item webpages to display an indication thereof. In other words, a user may view that other users have added the same retail item to their respective shopping carts.

The present shopping cart controller may monitor shopping cart events to determine the time remaining until the number of retail items added to shopping cart exceeds a threshold.

In embodiments, the present shopping cart controller may modify the functionality of the checkout controller wherein the shopping cart controller stores checkout data for subsequent utilisation when the threshold is met.

For example, as opposed to checking out an item right away, the user may elect to purchase the item at a later stage, potentially at a lower retail price wherein the user inputs the same identification, delivery and payment details in the checkout webpage as usual.

However, as opposed to the checkout controller processing the e-commerce transaction right away, the checkout controller stores the checkout data for subsequent use. The checkout controller may encrypt the checkout data, including generating credit card tokens with provided credit card details for subsequent use.

At a later stage, when the number of other users who have added the same retail item to their shopping cart and provided the relevant checkout data exceeds a threshold, the checkout controller may retrieve the store checkout data in relation to each shopping cart and automatically process the checkout by processing payment in the retail item is adjusted accordingly.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a shopping cart and checkout controller subsystem for e-commerce platform in accordance with an embodiment;

FIG. 2 shows an exemplary retail item webpage in accordance with an embodiment;

FIG. 3 shows an exemplary checkout webpage in accordance with an embodiment;

FIG. 4 shows subsystem of FIG. 1 interfacing a plurality of e-commerce retail platforms; and

FIG. 5 illustrates exemplary processing of the subsystem of FIG. 1 in accordance with an embodiment.

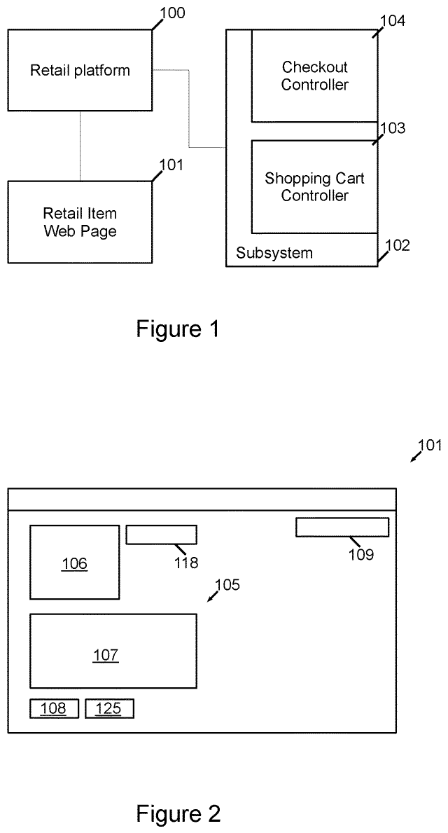

### DESCRIPTION OF EMBODIMENTS

A retail platform 100 comprises a server in operable communication with a plurality of client devices across a wide area network, such as the Internet. The retail platform 100 comprises a database of retail items and a web server which serves a plurality of respective webpages 101 in relation to the retail items. Each website displays information in relation to each retail item, including the retail price. Users browsing these retail item webpages may select retail items for adding to a shopping cart for subsequent checkout.

Adding a retail item to a shopping cart involves associating a selected retail item either with browser session data (if a user is not logged in) or against a user profile (if the user is logged in).

Terminating the browser session will lose data from the browser session data whereas shopping cart data stored against the user profile persists across browser sessions.

FIG. 2 shows an exemplary retail item webpage 101 which may comprise retail item details 105 including image data 106 and text data 107. The webpage 105 may comprise a button 108 for adding the retail item to a shopping cart or to proceed directly to checkout. The webpage 101 may comprise a shopping cart indicator 109 indicating that the item has been added to a user is shopping cart. Where a number of retail items have been added to the shopping cart, the shopping cart indicator 109 may display the associated number thereof.

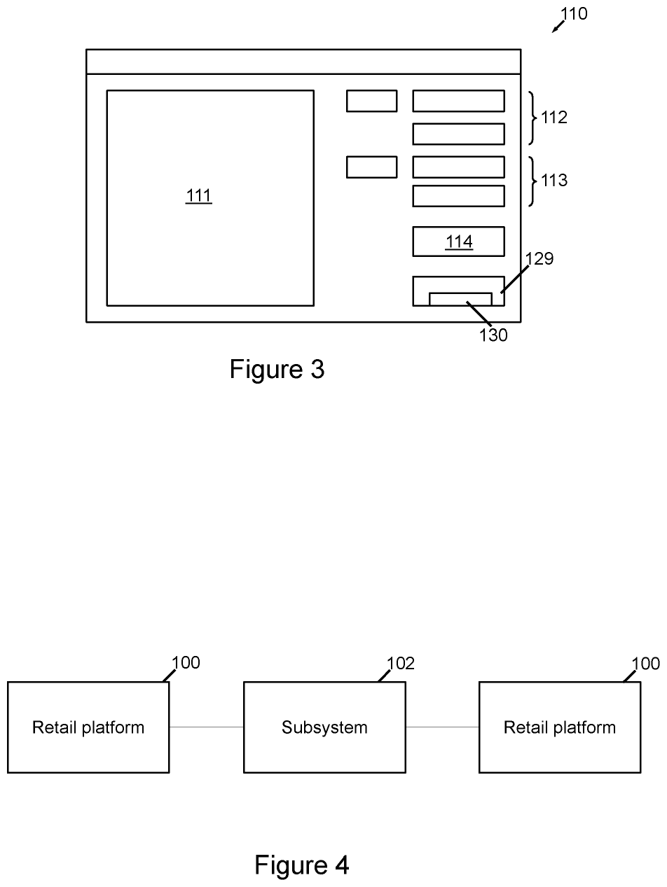

FIG. 3 shows an exemplary checkout page 110 which may comprise details 111 of one or more selected retail items and checkout input fields, including user identification and delivery details 112 and a payment details 113. For example, a user may input credit card details into the payment details fields 113. The checkout page 110 may comprise a checkout button 114 which initiates the checkout process, including processing payment using the provided payment details.

A shopping cart and checkout controller subsystem 102 has a shopping cart controller 103 for managing adding of retail items to a shopping cart. Specifically, the shopping cart controller 103 is configured to receive a selected retail item from a respective webpage 101 and add the selected retail item to a respective shopping cart by associating the selected retail item with at least one of respective browsing data and a user profile.

The subsystem 102 further comprise a checkout controller 104. The checkout controller 104 is configured for processing the purchase of a selected retail item for a retail price including with input payment details.

The subsystem 102 is specifically configured for detecting when the same retail item is added to a plurality of shopping carts and to control the checkout controller 104 to adjust a retail price of the retail item accordingly, typically downwardly.

The subsystem 102 may be implemented by reconfiguring the code base of a retail platform 100.

However, the subsystem 102 may alternatively be implemented by way of retail platform plug-in. In one embodiment, the subsystem 102 is provided as plug-in code executed by the server of the retail platform 100. In alternative embodiments, the subsystem 102 is provided as client-side code or browser add-on.

As shown in FIG. 4, the subsystem 102 may be configured to communicate with a plurality of retail platforms so as to be able to detect when the same type of retail item is added to a plurality of shopping carts of a number of different retail platforms 100.

In this regard, each retail platform 100 may expose an API usable by the subsystem 102 for receiving e-commerce events, including adding of retail items to shopping carts.

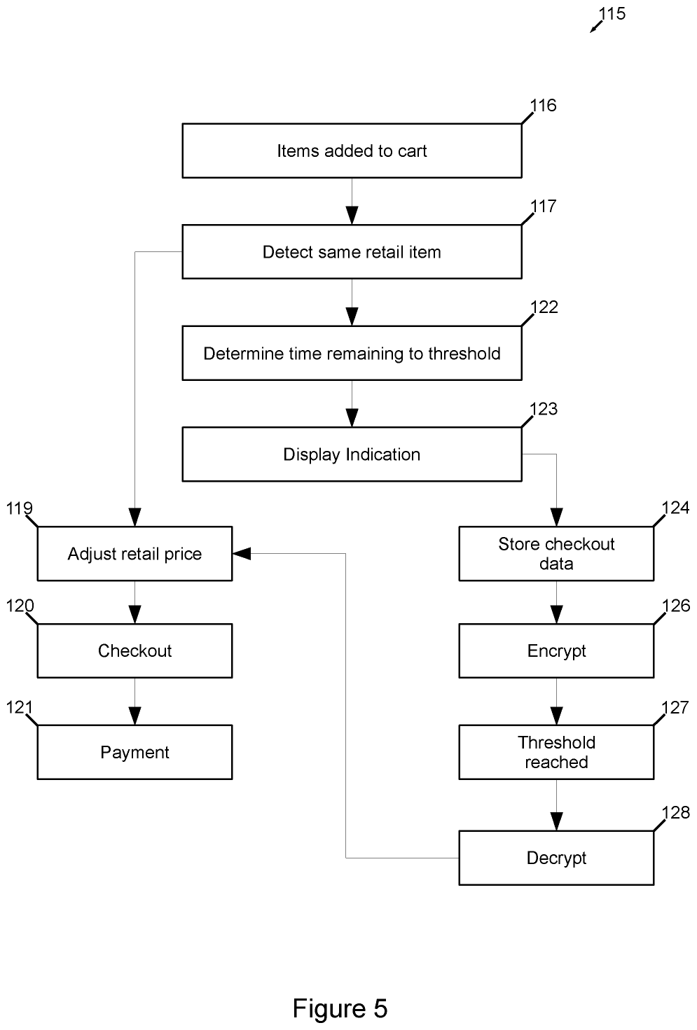

FIG. 5 illustrates exemplary processing 115 by the subsystem 102 in accordance with an embodiment.

The plurality of retail items is added to the database of the retail platform 100. Each retail item may be identified by a unique SKU number and may be associated with additional data, including product description data a retail price and the like.

Each retail item may further be associated with a threshold number at which the subsystem 102 is configured to adjust the retail price accordingly when a threshold number of retail items are added to shopping carts. In embodiments, each retail item may be further associated with a plurality of thresholds each of which at which the subsystem 102 is configured to adjust the retail price accordingly.

At step 116, shopping cart controller 103 is configured to detect the adding of a retail item to a shopping cart, either by being associated with use a browser session data (for a user which is not logged in) or with a user profile (for a user which is logged in).

The shopping cart controller 103 may replace the shopping cart functionality of an existing retail platform 103 or alternatively complement the functionality thereof, such as by communicating with an existing shopping cart module of the retail platform 100.

At step 117, the shopping cart controller 103 detects the adding of the same retail item to a plurality of shopping carts. For example, two or more users may add the same retail item to their shopping carts.

The shopping cart controller 103 may monitor shopping cart events received from the retail platform 100 and identify SKU numbers of retail items added thereto.

For uses which are not logged in, the shopping cart controller 103 may be provided with session identifiers for recording the sessions for which the same type of retail item has been added to a shopping cart.

The shopping cart controller 103 may build a lookup table of SKU numbers wherein a count is incremented for each SKU when the respective retail item is added to the shopping cart.

For session-based users, the entries may be removed from the lookup table upon expiration of the associated session. For registered users, the entries may be stored for a longer period according to the storage thereof against the user profile.

The shopping cart controller 103 may purge user account associated entries from the lookup table upon expiration of a predetermined time period, when an item is purchased or when the item is removed from the shopping cart by the user.

As shown in FIG. 2, the shopping cart controller 103 may cause the modification of the retail item webpage 101 to display an indication 118 that the retail item has been added to a plurality of shopping carts. In this way, users may see that other users are interested in purchasing the same retail item wherein the retail item may be available at an adjusted retail price (typically a discounted price).

When the shopping cart controller 103 detects that the threshold number has been reached, the shopping cart controller 103 may modify the webpage 101 to display the adjusted retail price at step 119.

Thereafter, the user may proceed to checkout at step 120 wherein the adjusted retail price is utilised for the making of payment at step 121.

The shopping cart controller 103 may provide a timeframe within which the retail item may be purchased at the adjusted price.

In embodiments, the shopping cart controller 103 may determine the time remaining until the threshold is reached at step 122.

For example, the shopping cart controller 103 may monitor the rate at which retail items are added to the shopping cart so as to predict the time remaining until the threshold is reached. For example, if five retail items of the same type are added to various shopping carts per hour on average, the shopping cart controller 103 may predict that the threshold will be met in approximately 20 hours.

In accordance with this embodiment, the shopping cart controller 103 may monitor the indication to display the estimated time remaining at step 123.

In embodiments, the shopping cart controller 103 may store checkout data for subsequent checkout processing at step 124.

Specifically, with reference to FIG. 2, as opposed to using the checkout button 108, the checkout controller 103 may insert a checkout later button 125 allowing the user to purchase an item at a later date as soon as the threshold is met.

Typically, the checkout button 108 may display the retail price whereas the checkout later button 125 may display the adjusted retail price, typically a discounted retail price.

Using the checkout later button 125, the user may proceed to the checkout page 110 and fill in the requisite details in the usual manner. Specifically, the user may input identification and delivery details and payment details 113, such as credit card details.

The checkout page 110 may be modified by the shopping cart controller 103 to indicate to the user and that checkout will be automatically processed later if the threshold number of retail items have similarly gone through this pre-checkout process.

At step 124, the shopping cart controller 103 stores the input checkout data. At step 126, the shopping cart controller 103 may encrypt the checkout data 124, especially to protect sensitive information, such as credit card details. Additionally, or alternatively, the shopping cart controller 103 may store a credit card token created using the credit card details and associated with the user profile.

At step 127 shopping cart controller 103 detects that the threshold number of retail items have been pre-purchased. For example, for a particular retail item having a threshold set as 100, shopping cart controller 103 may monitor the number of users who have not only added the same retail item to the shopping cart, but have also gone through the same pre-checkout process using the checkout controller 104.

When the threshold is met (that is when over 100 users have input their delivery details 112 and payment details 113) the checkout controller 104 may retrieve the checkout data, adjust the retail price at step 119 and perform the checkout process at step 120, including processing payment at step 121. As alluded to above, the checkout controller 104 may decrypt the checkout data at step 128.

In embodiments, as opposed to the user using the checkout later button 125, the shopping cart controller 103 may modify the checkout page 110 to include a checkout later button 129 which implements the aforedescribed process of storing the checkout data for subsequent use when the threshold is reached. The checkout later button 129 may display an indication 130 estimating the time remaining until the threshold is met.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A shopping cart and checkout controller subsystem for an e-commerce platform serving webpages for a plurality of retail items, the subsystem comprising:
a shopping cart controller configured to receive a selected retail item from a respective web page and add the selected retail items to a respective shopping cart by associating the selected retail item with at least one of a respective browser session and a user profile; and
a checkout controller processing the purchase of the selected retail item for a retail price including with input payment details, wherein
the subsystem is configured to detect when a number of retail items of the same type is added to a plurality of shopping carts and to control the checkout controller to adjust the retail price of the retail item.

2. The shopping cart and checkout controller subsystem as claimed in claim 1, wherein the subsystem is configured for storing checkout data, retrieving the checkout data when detecting that the number exceeds a threshold and using the retrieved checkout data to process the purchase of the retail item for the plurality of shopping carts.

3. The shopping cart and checkout controller subsystem as claimed in claim 2, wherein the subsystem encrypts the checkout data which is decrypted when retrieved.

4. The shopping cart and checkout controller subsystem as claimed in claim 2, wherein the subsystem generates a credit card token in relation to credit card details, the credit card token generated in accordance with a credit card details and associated with a respective user profile.

5. The shopping cart and checkout controller subsystem as claimed in claim 2, wherein, when detecting when that the number exceeds a threshold, shopping cart controller is configured to count only those for which respective payment details have been input.

6. The shopping cart and checkout controller subsystem as claimed in claim 2, wherein the checkout controller inserts checkout later button into at least one of a retail item webpage and a checkout webpage for allowing the user to purchase an item at a later date if the threshold is met.

7. The shopping cart and checkout controller subsystem as claimed in claim 2, wherein the subsystem is configured for monitoring the rate at which retail items of the same type are added to shopping carts and determining a time remaining until a threshold number may be reached.

8. The shopping cart and checkout controller subsystem as claimed in claim 1, wherein the subsystem modifies a webpage for a respective retail item to display an indication of the retail item having being added to other shopping carts.

9. The shopping cart and checkout controller subsystem as claimed in claim 9, wherein the subsystem is configured for monitoring the rate of the retail item being added to shopping carts, determining a time remaining until a threshold number may be reached and updating the indication of the retail item to indicate the remaining time.

10. The shopping cart and checkout controller subsystem as claimed in claim 1, wherein the subsystem interfaces a plurality of e-commerce platforms across a wide area network.

11. The shopping cart and checkout controller subsystem as claimed in claim 1, wherein the subsystem is a plug-in executed by a web server of the retail platform.

12. The shopping cart and checkout controller subsystem as claimed in claim 1, wherein the subsystem is implemented by a client-side code.

13. The shopping cart and checkout controller subsystem as claimed in claim 1, wherein the subsystem is implemented by a browser plug-in.

14. The shopping cart and checkout controller subsystem as claimed in claim 1, wherein the retail platform comprises a database comprising the plurality of retail items and wherein each retail item has an associated threshold at which the subsystem is configured to adjust the retail price.

15. The shopping cart and checkout controller subsystem as claimed in claim 14, wherein at least one item has an associated number of thresholds at each of which the subsystem is configured to adjust the retail price differently.

16. The shopping cart and checkout controller subsystem as claimed in claim 1, wherein, for users who are not logged in, the shopping cart controller uses session identifiers for recording the web browser sessions for which the same type of retail item has been added to a shopping cart.

17. The shopping cart and checkout controller subsystem as claimed in claim 16, wherein the shopping cart controller builds a lookup table of retail item identifiers wherein a count is incremented for each retail item when the respective retail item is added to the shopping cart.

18. The shopping cart and checkout controller subsystem as claimed in claim 17, wherein, for session-based users, entries from the lookup table are be removed from the lookup table upon expiration of the associated session.

19. The shopping cart and checkout controller subsystem as claimed in claim 17, wherein, for registered users, entries from the lookup table are stored in relation to user profile.

20. The shopping cart and checkout controller subsystem as claimed in claim 17, wherein the shopping cart controller purges entries from the lookup table at least one of upon expiration of a predetermined time period, when an item is checked out and when the item is removed from the shopping cart by the user.
